(19) United States
(12) Patent Application Publication
(10) Pub. No.: US 2013/0040180 A1
(43) Pub. Date: Feb. 14, 2013

(54) BATTERY MODULE FOR HIGH VOLTAGE BATTERY PACK

(71) Applicant: Hae Kyu Lim, Seoul (KR)

(72) Inventor: Hae Kyu Lim, Seoul (KR)

(73) Assignees: KIA MOTORS CORPORATION, Seoul (KR); HYUNDAI MOTOR COMPANY, Seoul (KR)

(21) Appl. No.: 13/312,933

(22) Filed: Dec. 6, 2011

(30) Foreign Application Priority Data
Aug. 10, 2011 (KR) 10-2011-0079635

(51) Int. Cl. H01M 10/50; H01M 10/02

(52) U.S. Cl. 429/120; 429/159

(57) ABSTRACT

A battery module is disclosed for a high voltage battery pack The battery module is configured so that a plurality of holder plates and a plurality of battery cells are stacked in a vertical direction, thus preventing a defective product from being produced due to incorrect assembly, and a required number of battery cells is stacked to be modularized, thus being advantageous in terms of a package and improving the cooling performance of the battery cells.

### CROSS-REFERENCE TO RELATED APPLICATIONS

This application claims under 35 U.S.C. §119(a) priority to Korean Application No. 10-2011-0079635, filed on Aug. 10, 2011, the disclosure of which is incorporated herein by reference in its entirety.

### BACKGROUND OF THE INVENTION

1. Field of the Invention

The present invention relates generally to a battery module forming a high voltage battery pack and, more particularly, to a battery module for a high voltage battery pack, in which a plurality of battery cells are stacked to form a module.

2. Description of the Related Art

Generally, hybrid electric vehicles, fuel cell vehicles and electric vehicles are vehicles that are driven using an electric motor, and are essentially equipped with a high voltage battery pack to provide drive power to the electric motor. The high voltage battery pack is configured to supply the required power by repeatedly charging and discharging while the vehicle is running Such a high voltage battery pack usually includes a battery casing, a plurality of battery modules installed in the battery casing, and a battery management system (BMS) configured to detect the voltage, the current, and the temperature of respective unit cells constituting the battery module so that their operation can be controlled.

As shown in FIG. 1, a conventional battery module includes a plurality of battery cells 1, and an upper plate 2 and a lower plate 3 supporting upper and lower portions of the battery cells 1. Each battery cell 1 is inserted into the lower plate 3 in such a way as to be erected upward. The upper portion of the battery cell 1 is inserted into the upper plate 2. For the assembly of the battery cell 1, the upper and lower plates 2 and 3 have insertion recesses 2a and 3a in which the battery cell 1 is fitted.

However, it is highly probably that when the cells are assembled they will be assembled incorrectly in the conventional design when upper and lower ends of each battery cell 1 are fitted into the insertion recesses 2a and 3a of the upper and lower plates 2 and 3. Particularly, since only the number of battery cells 1 corresponding to that of the insertion recesses 2a and 3a is modularized, the packaging nature of the battery module is disadvantageous.

The foregoing is designed merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the prior art, and an object of the present invention is to provide a battery module for a high voltage battery pack, intended to prevent a defective product from being produced due to incorrect assembly of battery cells and to form a module by stacking a required number of battery cells, thus being advantageous in terms of a packaging as well.

In order to accomplish the above object, the present invention provides a battery module for a high voltage battery pack for a vehicle, including a plurality of holder plates stacked in a vertical direction, and assembled to be spaced apart from each other at predetermined intervals; a plurality of battery cells supported by and seated on the holder plates in such a way that one battery cell is disposed between the holder plates; and a fastening member integrally coupling the holder plates to each other.

Each of the holder plates may include a metallic plate member on which each of the battery cells is seated, so that the metallic plate member supports the battery cell and functions to cool the battery cell; and a casing member integrated with the metallic plate member to form a frame of the metallic plate member, and supporting left and right ends of the battery cell.

The battery cells may include electrodes, respectively, the electrodes protruding from the left and right ends of the corresponding battery cell, and the electrodes may be connected to each other in a zigzag fashion so that a lowermost electrode is connected with an uppermost electrode, when the battery cells are stacked up by the holder plates.

The casing member may include on opposite ends thereof electrode mounting depressions to allow the electrodes of each of the battery cells to be inserted into and seated in the electrode mounting depressions.

A plurality of protruding portions may be integrally formed on the metallic plate member, and is brought into contact with the battery cell located under the metallic plate member to support the battery cell.

The metallic plate member may be made of aluminum to improve cooling performance of the battery cell, and the casing member may be made of plastic. The fastening member may include a plurality of long bolts integrally passing through corners of the stacked holder plates; and nuts fastened to the long bolts, respectively.

Preferably, air passages may be formed between the stacked holder plates and battery cells to allow cooling air to flow. Each of the holder plates may integrally include a plate protrusion and a plate depression to control a position at which the holder plate is assembled when the holder plates are stacked and assembled. The plate protrusion and the plate depression may be formed, respectively, on an upper surface and a lower surface of the casing member of the holder plate in such a way as to be aligned in a row.

A battery module for a high voltage battery pack according to the present invention is advantageous in that a plurality of holder plates and a plurality of battery cells are stacked in a vertical direction, thus preventing a defective product from being produced due to incorrect assembly, and a required number of battery cells is stacked to be modularized, thus being advantageous in terms of a packaging and improving the cooling performance of the battery cells.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a conventional battery module;

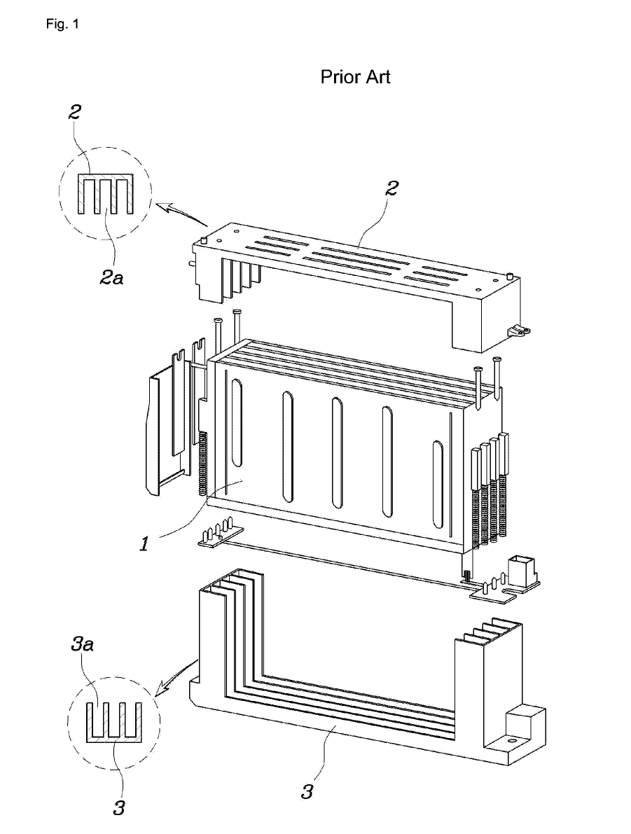

FIG. 2 is a perspective view illustrating an assembled battery module in accordance with an exemplary embodiment of the present invention;

FIG. 3 is an exploded perspective view illustrating a process of assembling the battery module in accordance with the exemplary embodiment of the present invention; and

FIGS. 4 to 6 are sectional views taken along line I-I-, line II-II and line III-III of FIG. 2, respectively.

### DESCRIPTION OF PREFERRED EMBODIMENTS

Hereinafter, a battery module for a high voltage battery pack according to a preferred embodiment of the present invention will be described with reference to the accompanying drawings.

It is understood that the tem “vehicle” or “vehicular” or other similar tem as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

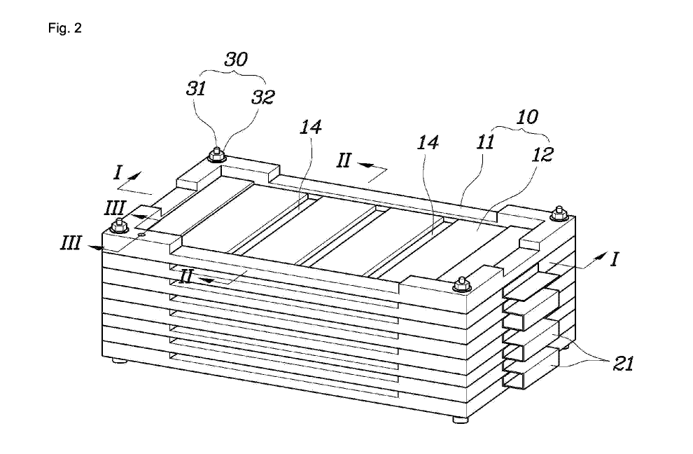

As shown in FIGS. 2 to 6, the battery module for the high voltage battery pack according to the present invention includes a plurality of holder plates 10, a plurality of battery cells 20, and a fastening member 30. The holder plates 10 are stacked in a vertical direction, and are assembled to be spaced apart from each other by a predetermined interval. The battery cells 20 are supported by and seated on the holder plates 10 in such a way that one battery cell 20 is disposed between the holder plates 10. The fastening member 30 integrally couples the holder plates 10 to each other.

Here, each holder plate 10 includes a metallic plate member 11 and a casing member 12. The battery cell 20 is seated on the metallic plate member 11, so that the member 11 supports the battery cell 20 and functions to cool the battery cell 20. The casing member 12 is integrated with the metallic plate member 11 to form a frame of the metallic plate member 11, and supports left and right ends of the battery cell 20.

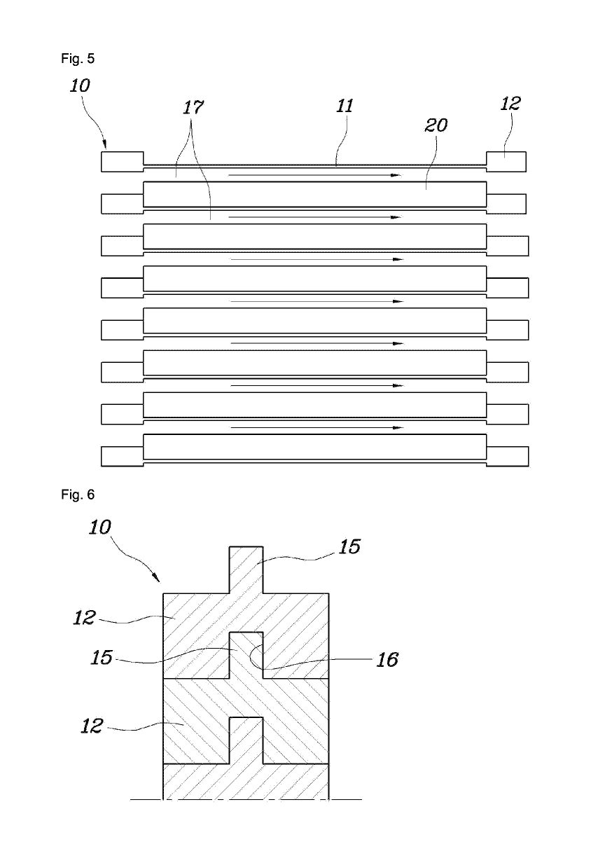

Further, the battery cells 20 have electrodes 21, respectively. The electrodes 21 protrude from the left and right ends of the corresponding battery cell 20. The electrodes 21 are connected to each other in a zigzag fashion as shown in FIG. 4 so that the lowermost electrode 21 is connected with the uppermost electrode 21 when the battery cells 20 are stacked up using the holder plates 10. The electrode mounting depressions 13 are formed on opposite ends of the casing member 12 so that the electrodes 21 of each battery cell 20 are inserted into and seated in the electrode mounting depressions 13.

A plurality of protruding portions 14 are integrally formed on each metallic plate member 11, and are brought into contact with the upper surface of the battery cell 20 located under the metallic plate member 11 to support the battery cell 20 and suppress movement of the battery cell 20.

The metallic plate member 11 may be made of aluminum (Al) to improve cooling performance of the battery cell 20. The casing member 12 may be made of plastic. By making the metallic plate member 11 of aluminum the plate members 11 may further improve the cooling performance of the battery cell 20 because aluminum has good thermal conductivity. Furthermore, by making the casing member 12 out of plastic the illustrative embodiment of the present invention is able to lighten the structure, improve durability, and provide electrical insulation. Additionally, the metallic plate member 11 and the casing member 12 may be integrated into a single structure by insert molding.

The fastening member 30 includes a plurality of long bolts 31 passing integrally through corners of the stacked holder plates 10, and nuts 32 fastened to the long bolts 31, respectively.

Further, each holder plate 10 integrally includes a plate protrusion 15 and a plate depression 16 to control the position at which the holder plate 10 is assembled when the holder plates 10 are stacked and assembled. Here, the plate protrusion 15 and the plate depression 16 are formed on the casing member 12. The plate protrusion 15 and the plate depression 16 may be formed, respectively, on an upper surface and a lower surface of the casing member 12 in such a way as to be aligned in a row.

Preferably, air passages 17 are formed between the holder plates 10 and the battery cells 20, which are stacked up, to permit the passage of air that performs cooling. Hereinafter, the process of assembling the battery module according to the present invention will be described.

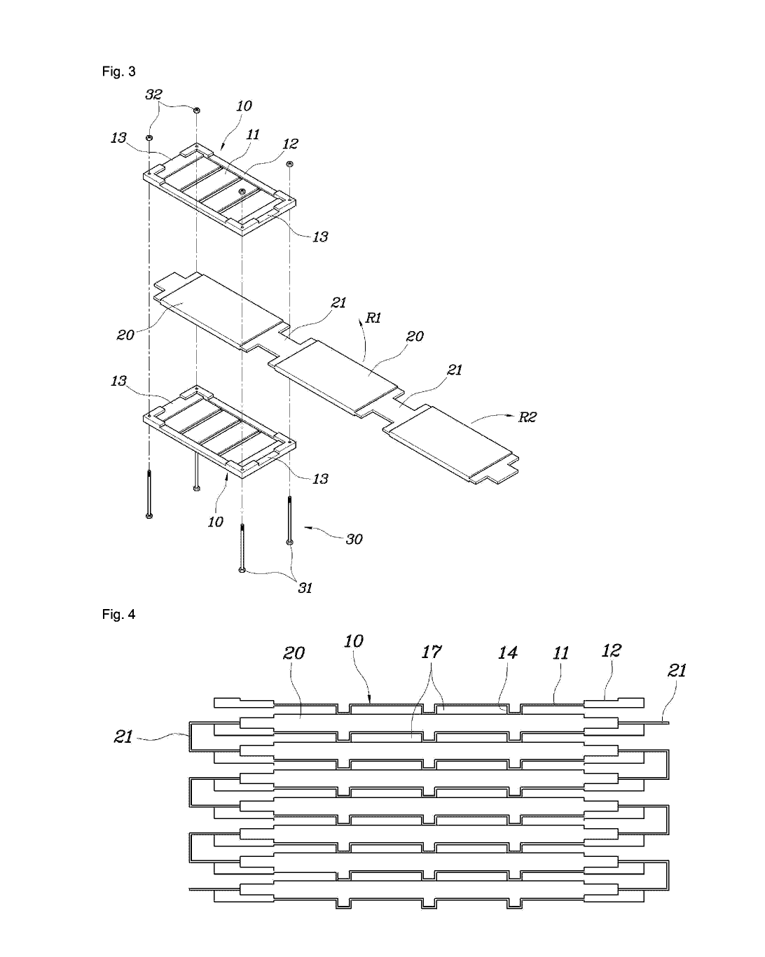

One holder plate 10 having the metallic plate member 11 and the casing member 12 is placed on the ground. Thereafter, as shown in FIG. 3, one battery cell 20 is seated on the holder plate 10. The battery cells 20 can be connected to each other in a row, and can be configured so that the electrodes 21 thereof are connected to each other. If one battery cell 20 is seated on the holder plate 10, the battery cell 20 is seated on the metallic plate member 11, the edge of the battery cell 20 is seated on the casing member 12, and the electrodes 21 are inserted into the electrode mounting depressions 13 formed on left and right ends of the casing member 12.

After one battery cell 20 is seated on one holder plate 10, another holder plate 10 is seated on the battery cell 20. Next, another battery cell 20 is rotated and seated as shown by the arrow R1 of FIG. 3. Subsequently, another holder plate 10 is seated on the battery cell 20, and another battery cell 20 is rotated and seated on the holder plate 10 as shown by the arrow R2 of FIG. 3. In this way, the plurality of holder plates 10 and the plurality of battery cells 20 are stacked vertically as shown in FIG. 4. Further, the battery cells 20 are connected to each other by the electrodes 21 that are connected to each other in a zigzag fashion.

The holder plates 10 and the battery cells 20 stacked up and secured in place and two each other by the fastening member 30 including, for example, the long bolts 31 and the nuts 32. The stacked battery cells 20 are supported by the protruding portions 14 of the metallic plate members 11 so as to prevent the battery cells 20 from moving. Further, if the holder plates 10 and the battery cells 20 are stacked vertically, the air passages 17 are defined between the holder plates 10 and the battery cells 20 to permit the passage of air that performs cooling. Accordingly, the battery module according to the present invention is advantageous because a plurality of battery cells 20 are stacked vertically, thus preventing defective products that are incorrectly assembled from being produced. Further, a desired number of battery cells 20 are stacked up to form a module, so that it is advantageous in terms of packaging as well. Additionally, t a protruding portion 14 of a metallic plate member 11, which may be made of aluminum, is brought into contact with a battery cell 2 during the assembly, so that the cooling performance of the battery cell 20 is further improved by the high thermal conductivity of aluminum. Further, air passages 17 are formed above and under stacked battery cells 20 to permit the passage of air for cooling, thus improving the cooling performance of the battery cell 20. In addition, when a plurality of holder plates 10 are stacked up, plate protrusions 15 are fitted into corresponding plate depressions 16, thus preventing the incorrect assembly of the holder plate 10 and controlling the assembly position. Moreover, the battery module according to the present invention is advantageous because a casing member 12 of a holder plate 10 is made of plastic, thus achieving lightness, improving durability, preventing heat invasion from the outside, and providing electrical insulation.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A battery module for a high voltage battery pack for a vehicle, comprising:
a plurality of holder plates stacked in a vertical direction, and assembled to be spaced apart from each other at predetermined intervals;
a plurality of battery cells supported by and seated on the holder plates wherein one battery cell is disposed between the holder plates; and
a fastening member integrally coupling the holder plates to each other.

2. The battery module as set forth in claim 1, wherein each of the holder plates comprises:
a metallic plate member on which each of the battery cells is seated, wherein the metallic plate member supports the battery cell and functions to cool the battery cell; and
a casing member integrated with the metallic plate member to form a frame of the metallic plate member, and supporting left and right ends of the battery cell.

3. The battery module as set forth in claim 1, wherein the battery cells include electrodes, respectively, the electrodes protruding from the left and right ends of the corresponding battery cell, and
the electrodes are connected to each other in a zigzag formation wherein a lowermost electrode is connected with an uppermost electrode, when the battery cells are stacked up by the holder plates.

4. The battery module as set forth in claim 2, wherein the casing member comprises on opposite ends thereof electrode mounting depressions to allow the electrodes of each of the battery cells to be inserted into and seated in the electrode mounting depressions.

5. The battery module as set forth in claim 2, wherein a plurality of protruding portions is integrally formed on the metallic plate member, and is brought into contact with the battery cell located under the metallic plate member to support the battery cell.

6. The battery module as set forth in claim 2, wherein the metallic plate member is made of aluminum to improve cooling performance of the battery cell, and
the casing member is made of plastic.

7. The battery module as set forth in claim 1, wherein the fastening member comprises:
a plurality of long bolts integrally passing through corners of the stacked holder plates; and
nuts fastened to the long bolts, respectively.

8. The battery module as set forth in claim 1, wherein air passages are formed between the stacked holder plates and battery cells to allow cooling air to flow therethrough.

9. The battery module as set forth in claim 1, wherein each of the holder plates integrally comprises a plate protrusion and a plate depression to control a position at which the holder plate is assembled when the holder plates are stacked and assembled.

10. The battery module as set forth in claim 9, wherein the plate protrusion and the plate depression are formed, respectively, on an upper surface and a lower surface of the casing member of the holder plate in such a way as to be aligned in a row.
